(19) United States
(12) Patent Application Publication
(10) Pub. No.: US 2005/0147377 A1
(43) Pub. Date: Jul. 7, 2005

(54) Electronic device, information transfer device, information transfer method, and its program

(75) Inventors: Rieko Kobayashi, Tokyo (JP); Atsuto Ohashi, Tokyo (JP); Seishi Hirao, Tokyo (JP); Yoshihiro Chosokabe, Nagano (JP); Junichiro Sakata, Tokyo (JP); Qinwei Wang, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/963,519

(22) Filed: Oct. 14, 2004

(30) Foreign Application Priority Data
Oct. 28, 2003 (JP) 2003-368163

(51) Int. Cl. H04N 5/76; H04N 5/781

(52) U.S. Cl. 386/46; 386/125

(57) ABSTRACT

Disclosed is electronic device, information transfer device, information transfer method, and its program to enable advanced booking of transfer of information whose recording has not been generated in one device and automatic transfer of the recording to another device as soon as the recording is generated. The method of the invention comprises early storing identification information for content that was set to be recorded in a given storage area at a first time; when recording of the content has finished, receiving the content identification information; comparing the early stored identification information and the received identification information for a match; if the match of the identification information is judged as the result of the comparison, storing the identification information of the match; and retrieving the content with the stored identification information from the given storage area, based on the identification information, and transferring the content to the terminal.

### BACKGROUND OF THE INVENTION

1. Field of the Invention

The present invention relates to an electronic device that can transfer information such as pictures to external device through communication with the external device, an information transfer device, an information processing method, and its program.

2. Description of Related Art

As smaller recording means with larger capacity have lately been available, a system that downloads part of information recorded in a stationary recording/playback device with a hard disk drive (hereinafter referred to as HDD) built in it to a portable playback device with HDD built in it so that the information can be replayed on the portable device outdoor is being developed. In this system, the stationary recording/playback device is responsible for managing the portable playback device; e.g., it transfers information to the portable playback device in response to a download request from the portable playback device.

(For Example, Refer to Patent Document 1.)

[Patent document 1] JP-A No. 2002-118813 (typically, FIG. 4).

Actually, when the stationary recording/playback device transfers information to the portable playback device, data as a recording of any content must be transferred. For example, in a case where moving picture streams of a TV program recording are transferred, a program that is booked to be recorded but has not been recorded cannot be transferred because its recording consisting of moving picture streams does not exist. In such a case, after confirming that recording the program booked to be recorded has finished and its recording has been generated, transfer of the recording will be performed. However, it takes a lot of trouble and time for the user to make sure that recording of a program booked to be recorded has finished and operate the device to transfer the recording each time the recording has been made and this degrades the usability.

### SUMMARY OF THE INVENTION

In view of the foregoing limitation, the object of the present invention is to provide an electronic device, information transfer device, information transfer method, and its program to enable advanced booking of transfer of information whose recording has not been generated in one device and automatic transfer of the recording to another device as soon as the recording is generated.

In order to achieve the foregoing object, an electronic device according to a primary aspect of the present invention comprises a recording setting means for setting content to be recorded at a first time; a recording means for recording the content at the first time, according to setting by the recording setting means; a transfer setting means for setting at least one content that was set by the recording setting means to be transferred to a terminal; a detection means for detecting that the content set to be transferred has been recorded by the recording means; and a transfer means for transferring the content detected to have been recorded to the terminal.

The content may include, but not limited to, e.g., moving picture streams of a TV program recording and moving picture streams downloaded via the Internet or the like. The first time is a scheduled time to record content, e.g., in booking for recording the TV program.

The terminal is typically “a portable device with HDD for playing back moving pictures” (hereinafter abbreviated to “PDH” for convenience). The PDH can store moving picture streams on the HDD and playing back the streams.

According to this arrangement, it is possible to set content whose recording has not finished to be transferred to a terminal so that the content can be transferred automatically to the terminal after its recording finishes. Thus, the user does not have to check if recording has finished for each stream and operate the device to transfer the recording each time the recording has been made and trouble and time in user operation required can be eliminated.

In particular, the above transfer setting means sets the content to be transferred to the terminal at a second time. On the second time, when the detection means detects that the content has been recorded, the transfer means transfers the content to the terminal. On the second time, when the detection means does not detect that the content has been recorded, the content may be transferred only after it is detected that the content has been recorded.

The second time is, for example, time at which the user wants the content transferred to the terminal. According to this arrangement, when content is set to be transferred at the second time, the content whose recording has finished on the second time will be transferred to the terminal and the content whose recording has not finished on the second time can be transferred automatically as soon as the recoding finishes. Even the content whose recording has not finished by the time that was set by user preference can be transferred automatically and usability for the user is improved.

The electronic device may further comprise a confirmation means for confirming connection to the terminal such that the transfer means transfers the content to the terminal after the connection to the terminal is confirmed by the confirmation means.

Connection to the above terminal is made by, e.g., USB cable and the like. In this arrangement, once connection to the terminal has been made, content can be transferred automatically to the terminal.

Means for comparing the total amount of a plurality of contents set to be transferred with free space of storage in a terminal to which the plurality of contents will be transferred may be included. If the free space is less than the total amount, according to the result of the comparison, the transfer means transfers at least one content with the total amount being less than the free space to the terminal.

According to this arrangement, even if the total amount of contents to be transferred is greater than the free space of storage in the terminal, some of these contents that are transferable to the terminal within the capacity limit can be transferred.

The electronic device may further comprise means for setting content that was set to be recorded at the first time by the recording setting means to be recorded periodically at the first time and at intervals of a given number of days. If the way of setting content to be recorded periodically is effected, and when the content is recorded at the first time on a particular day by the recording means, means for setting the recording setting means to record the content at the first time on a day after the interval of a given number of days from the particular day may be included in the above device. When the content is set to be recorded at the first time on the data after the interval of a given number of days, the transfer setting means sets the thus set content to be transferred to the terminal.

The given number of days may be, for example, one day, one week, etc. and periodical recording refers to recording that is repeated on the first time, e.g., everyday or every week. According to this arrangement, even content that was set to be recorded periodically can be transferred to the terminal by setting of the transfer setting means.

According to another aspect of the present invention, an information transfer device is provided which transfers content that was set to be recorded in a given storage area at a first time to a terminal, using information identifying the content. The information transfer device comprises a first storage means for storing identification information for the content that was set to be registered; a receiving means which, when recording of the content has finished, receives the content identification information; a comparison means which compares the identification information stored by the storage means and the identification information received by the receiving means for a match; a second storage means which, if the match of the identification information is judged by the comparison means, stores the identification information of the match; and a transfer means which retrieves the content with the identification information stored by the second storage means from the given storage area, based on the identification information, and transfers the content to the terminal.

According to yet another aspect of the present invention, an information transfer method for transferring content that was booked and set to be recorded in a given storage area at a first time to a terminal is provided. The information transfer method comprises the steps of storing identification information for the content that was booked and set to be recorded; receiving identification information for content whose recording has finished; comparing the identification information for the content that was booked and set to be recorded and the identification information for content whose recording has finished for a match; if the match of the identification information is judged, storing the identification information of the match; and retrieving the content with the identification information of the match from the given storage area and transferring the content to the terminal.

According to a further aspect of the present invention, a program is provided. To transfer content that was set to be recorded in a given storage area at a first time to a terminal, using identification information to identify the content, the program causes a computer to function as a first storage means for storing identification information of the content set to be recorded; a receiving means which, when recording of the content has finished, receives the content identification information; a comparison means which compares the identification information stored by the storage means and the identification information received by the receiving means for a match; a second storage means which, if the match of the identification information is judged by the comparison means, stores the identification information of the match; and a transfer means which retrieves the content with the identification information stored by the second storage means from the given storage area, based on the identification information, and transfers the content to the terminal.

The identification information is, e.g., ID that is assigned to an individual content. According to this arrangement, using the above identification information, recording and transfer of content with the identification information are managed. Through this management, it is possible to set content whose recording has not finished to be transferred to a terminal so that the content can be transferred automatically to the terminal after its recording finishes. Thus, the user does not have to check if recording has finished for each stream and operate the device to transfer the recording each time the recording has been made and trouble and time in user operation required can be eliminated.

The information transfer device may further comprise a transfer setting means for setting the content to be transferred at a second time. If the match of the identification information is judged by the comparison means on the second time, the second storage means stores the identification information. If a mismatch of the identification information is judged by the comparison means on the second time, the second storage means will store the identification information only after the match of the identification information is judged.

The information transfer method may further comprises a step (f) of setting the content to be transferred at a second time, wherein if the match of the identification information is judged by the step (c) on the second time, the step (d) stores the identification information; if a mismatch of the identification information is judged by the step (c) on the second time, the step (d) will store the identification information only after the match of the identification information is judged.

The information transfer device may further comprise a confirmation means for confirming connection to the terminal, wherein the transfer means transfers the content to the terminal after the connection to the terminal is confirmed by the confirmation means.

The information transfer method may further comprise a step (g) of confirming connection to the terminal, wherein the step (e) transfers the content to the terminal after the connection to the terminal is confirmed by the step (g).

In the above information transfer device, preferably, the transfer means may convert the content into a predetermined format if the content is not the predetermined format.

In the above information transfer method, preferably, the step (e) may convert the content into a predetermined format if the content is not the predetermined format.

According to the preset invention, even for information whose recording has not been generated in one device, its recording can be set to be transferred automatically to another device as soon as the recording is generated. Other and further objects, features and advantages of the invention will appear more fully from the following description.

### BRIEF DESCRIPTION OF THE DRAWINGS

FIG. 1 is a perspective view showing the external appearance of a PDH according to one embodiment of the present invention;

FIG. 2 is a front plan view of the PDH of FIG. 1;

FIG. 3 is a cross-sectional view of the PDH of FIG. 1;

FIG. 4 is a top plan view of the PDH of FIG. 1;

FIG. 5 depicts only the casing 1 in the device's cross-sectional view of FIG. 3;

FIG. 6 is a diagram showing the arrangement of the circuits installed on the main substrate in the PDH;

FIG. 7 shows an action menu example;

FIG. 8 shows a title list example;

FIG. 9 shows an environment setting screen example;

FIG. 10 shows a screen example that presents the elapsed (remaining) time of playback of moving picture stream;

FIG. 11 is a cross-sectional view showing another embodiment of the PDH of the present invention;

FIG. 12A is the plan view of an LCD layer (front side) in the PDH of FIG. 1;

FIG. 12B consists of the plan views of a main substrate layer (front side) and an HDD substrate layer (front side) in the PDH of FIG. 1;

FIG. 12C is the plan view of the HDD layer (front side) in the PDH of FIG. 1;

FIG. 12D is the plan view of the main substrate layer (back side) in the PDH of FIG. 1;

FIG. 12E is the plan view of the HDD substrate layer and HDD layer (back side) in the PDH of FIG. 1;

FIG. 13 is a flowchart illustrating the procedural steps from power-on to the start of moving picture playback for the PDH of FIG. 1;

FIG. 14 is a block diagram showing a PC 200 configuration according to one embodiment of the present invention;

FIG. 15 is a diagram showing a simplified structure of a transfer system in the present embodiment;

FIG. 16 is a flowchart illustrating the operation of recording moving picture streams by a picture recording application;

FIG. 17 shows an example of a recording list box that is displayed when the picture recording application is executed;

FIG. 18 shows exemplary windows that are displayed when transfer of moving picture streams is performed using the picture recording application and transfer application;

FIG. 19 shows an example of a transfer list table 1901 that is stored within the transfer application to manage the moving picture streams listed in a transfer list box 1802;

FIG. 20 is a flowchart illustrating an operation in which the transfer application transfers moving picture streams;

FIG. 21 shows an exemplary window that is displayed when an automatic transfer function is used;

FIG. 22 is a flowchart illustrating an operation in which automatic transfer is performed by timer transfer;

FIG. 23 shows a window example that is displayed when transfer booking is performed in the transfer application;

FIG. 24 is a flowchart illustrating an operation in which moving picture streams are moved from the transfer booking list box to the transfer list box; and

FIG. 25 is a sequence diagram that summarizes data transfer between the picture recording application and the transfer application.

### DETAILED DESCRIPTION OF THE PREFERRED EMBODIMENTS

Preferred embodiments of the present invention will be described hereinafter, based on the drawings.

First, a PDH (abbreviated to “PDH” hereinafter) as a terminal to which data such as moving picture streams is transferred from a stationary electronic device is now discussed.

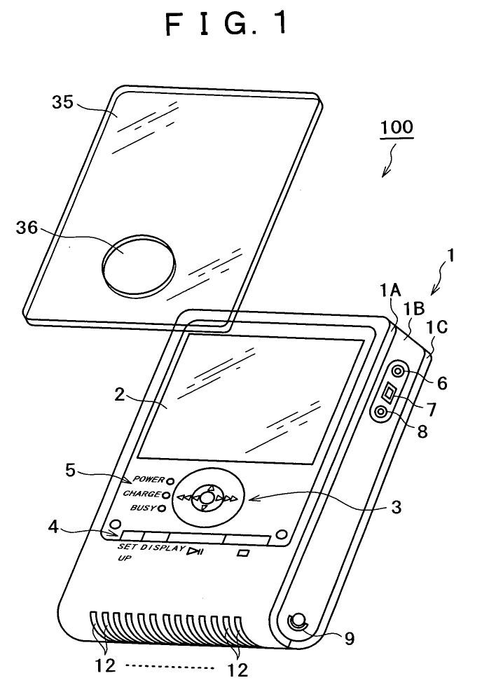

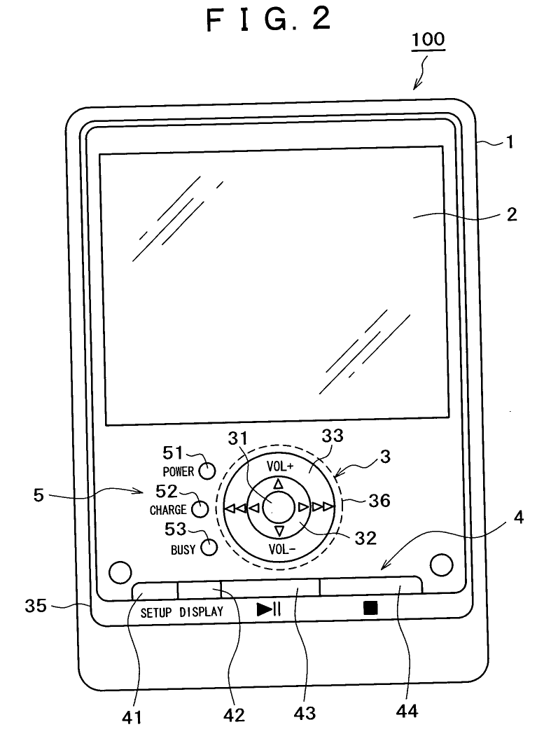

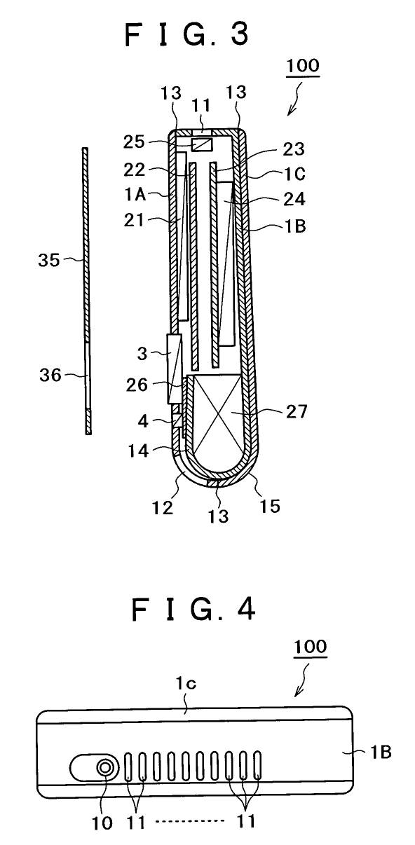

FIG. 1 is a perspective view showing the external appearance of the PDH according to one embodiment of the present invention. FIG. 2 is a front plan view of this PDH 100. FIG. 3 is a cross-sectional view of the same device. FIG. 4 is a top plan view of this PDH.

This PDH 100 has a casing 1 of size that is small enough to be held in the palm of one hand. On the front side of the casing 1, there are an LCD display 2, a multi-selector 3, operation buttons 4, and Light Emitting Diode (LED) lamps 5.

The multi-selector 3 consists of three keys 31, 32, 33 that are disposed concentrically and can be operated separately, as shown in FIG. 2. The central key is the ENTER key 31 to select or execute an item. A menu/select key 32 at the outer side of the ENTER key 31 is used to select an item from a menu. At the outer side of the menu/select key 32, there is a playback control key 33 that is used for playback operation.

The menu/select key 32 and the playback control key 33 are designed such that, by pressing their up, down, left, and right positions concentric on the ENTER key 31, corresponding key commands are issued. The key commands that are issued by the menu/select key 32 include, but not limited to, the commands to move the focus position up, down, to the left, and to the right, to select an item from one of various menus which will be described later. The key commands that are issued by the playback control key 33 include, but not limited to, the commands to fast-forward and rewind the playback and increase and decrease the sound volume.

The operation buttons 4 comprise, but not limited to, a SETUP button 41 to bring up a screen for setting, a DISPLAY button 42 to display, e.g., time elapsed (remaining) in playing back moving picture streams, a PLAY button 43 to command the start of playback and a pause, and a STOP button 44 to command the stop of playback.

The LED lamps 5 comprises, but not limited to, a power-on indicator 51 to indicate the power-on state of the device, a charge indicator 52 to indicate that the battery is being charged, and a busy indicator 53 to indicate the busy state of the device such as when streams are being transferred to the device.

On one side of the casing 1, there are a DCIN jack 6 for DC power supply connection, a USB connector 7 for Universal Serial Bus (USB) connection, and an AVOUT jack 8 for AV output in order of mention from the top. There is also a strap eyelet 9. On the other side of the casing 1, there is a PWR key (not shown) to turn the device's main power ON/OFF. On the top of the casing 1, there are a headphone jack 10 and many air outlet slits 11 that are evenly spaced, as shown in FIG. 4. On the bottom of the casing 1, there are may air inlet slits 12 that are evenly spaced.

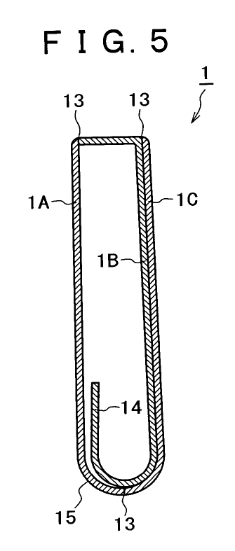

FIG. 5 depicts only the casing 1 in the device's cross-sectional view of FIG. 3. As shown in this figure, the casing 1 consists of a front casing part 1A, an intermediate casing part 1B, and a rear casing part 1C. The front casing part 1A and the rear casing part 1C primarily form the front and rear exteriors respectively of the PDH 100. The intermediate casing part 1B comprises the top side portion and the left and right side portions of the exterior of the PDH 100. The top side portion of the casing 1 has the above air outlet slits 11 as shown in FIG. 4. The front casing part 1A and the rear casing part 1C are jointed together with the intermediate casing part 1B being sandwiched between them. The bottom of the casing 1 is formed in a half round shape 15 in the cross section. In this half round shape section 15, the front casing part 1A and the rear casing part 1C are butt jointed together. In the half round shape section 15, the bottom of the front casing part 1A has the above air inlet slits 12. The bottom of the intermediate casing part 1B is bent in a U shape in the cross section along the half round shape section 15 at the bottom of the casing 1. This section is referred to as a bent section 14 of the intermediate casing part 1B.

A transparent acrylic cover 35 that can cover the LCD display 2 and operation buttons 4 can be installed on and removed from the front of the casing 1. This acrylic cover 35 is intended to protect the LCD display 2 from being damaged and screen out dust on the display. This acrylic cover 35 has an opening 36 to expose the multi-selector 3 so that the user can operate the multi-selector 3 when the acrylic cover 35 is installed.

Next, the internal structure of this PDH 100 is discussed.

The internal components in the casing 1 are divided into two groups according to the arrangement thereof: one group of components installed in the upper space and the other group of components installed in the lower space when viewing the PDH 100 in the upright posture. The group of components installed in the upper space comprises, but not limited to, a backlit LCD 21, main substrate 22, HDD substrate 23, HDD 24, and cooling fan 24. The group of components installed in the lower space comprises, but not limited to, a composite inverter substrate 26 and battery pack 27. Heat is mainly generated from the LCD 21, main substrate 22, and HDD 24 installed in the upper space within the PDH 100. By comparison of their caloric values, it is generally true that LCD 21>main substrate 22>HDD 24.

In this PDH 100, these primary heat generating components are disposed in order of high to low caloric values in the direction from the front to rear. By choosing this disposition, heating of the rear casing part 1C can be suppressed lower than when they are not disposed in this order. This PDH 100 is designed so that the user can enjoy a moving picture while holding it by hand. Thus, the user views the picture with the palm of the user's hand being in contact with the surface of the rear casing part 1C, the contact surface being the widest as compared with the contacts with other exteriors of the device. By minimizing the temperature rise of the rear casing part 1C, the degree of uncomfortable feeling of the user by the heat generation of the device can be reduced.

Heat generated within the casing 1 can be discharged to the outside with air flow that is produced by the cooling fan 25 installed in the highest position within the casing 1. Air enters the casing from the air inlet slits 12 provided on the bottom of the casing 1 and goes out through the air outlet slits 11 on the top of the casing 1 shown in FIG. 4. In this way, the heat generating components within the casing 1 are cooled efficiently and, therefore, the heat problem to the user will be more mitigated.

On the inside of the U-shape bent section 14 of the intermediate casing part 1B, the battery pack 27 for power supply is installed, surrounded by the bent section. Between the flat end of this bent section 14 and the front wall (on which the display is present), the composite inverter substrate 26 is supported. Thus, the battery pack 27 and the composite inverter substrate 26 are isolated by the bent section 14 of the intermediate casing part 1B. The composite inverter substrate 26 is a substrate on which components pertaining to the actions of the operation buttons 4 and the multi-selector 3, the inverter for driving the backlight of the LCD 21, and others are installed. Like this, since the battery pack 27 and the composite inverter substrate 26 are isolated by the bent section 14 of the intermediate casing part 1B, it can be avoided that the composite inverter substrate 26 is affected by liquid leakage from the battery pack 27. Also, this isolation avoids that force exerted when operating the multi-selector 3 is directly applied to the battery pack 27, which can help protect the battery pack 27.

Because the battery pack 27 does not generate much heat, installing it at the bottom rear position that will come in contact with the palm of the user's hand most frequently poses no problem. Since the specific gravity of the battery pack 21 is highest, that is, it has the greatest weight, among the components installed within the casing 1, installing the battery pack 27 at the bottom of casing 1 helps improve the stability of holding the PDH 100 when the user views a picture.

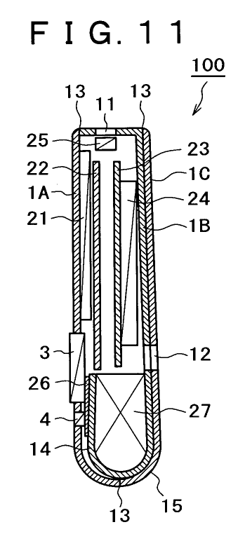

While the air inlet slits 12 are located on the bottom of the PDH 100 in the present embodiment as shown in FIG. 3, the air inlet slits 12 may be located just above the battery pack 27 on the rear side of the casing 1 as is shown in FIG. 11.

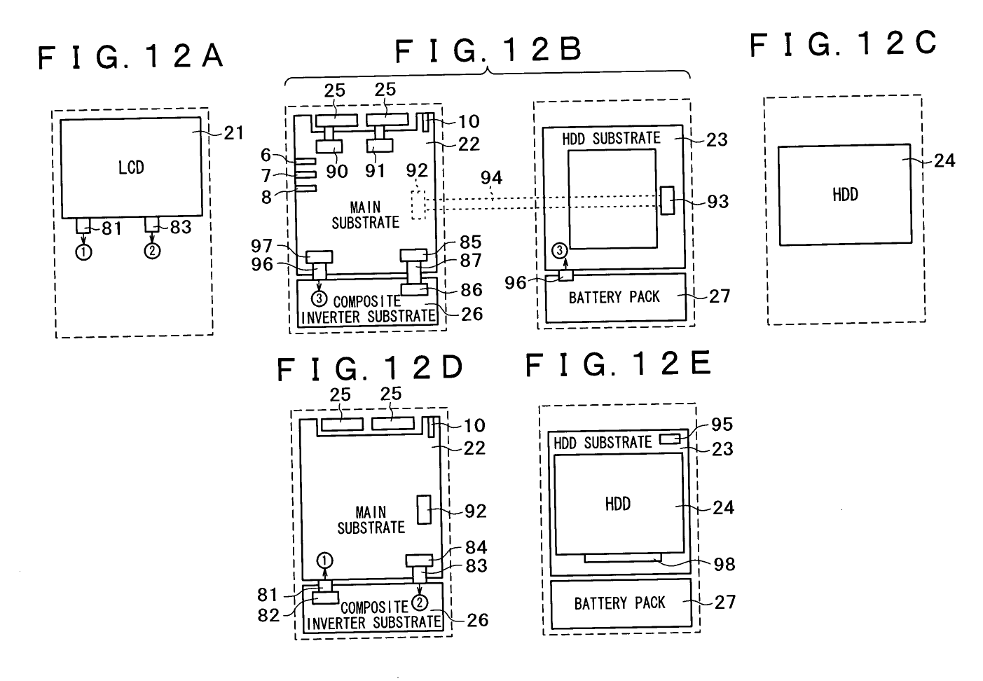

FIGS. 12A through 12E are plan views of layers of internal structure of the PDH 100. The backlight of the LCD 21 is connected through connection wiring 131 to a connector 132 mounted on the front side of the composite inverter substrate 26, where the front side faces toward the device front with the display. From the composite inverter substrate 26, signals required for turning the backlight on and control are supplied to the backlight of the LCD 21 through the connection wiring 131. The LCD 21 is also connected through connection wiring 133 to a connector 134 mounted on the back side of the main substrate 22, where the back side faces toward the rear of the device. From the main substrate 22, required singles are supplied to the LCD 21 through the connection wiring 133. The main substrate 22 and the composite inverter substrate 26 are electrically interconnected through connecting wiring 137 between connectors 135, 136 and connectors 135, 136 respectively mounted on the front sides of both substrates and communicate with each other to transfer required signals between them. Moreover, on the front side of the main substrate 22, there are two connectors 140, 141 to which one ends of connection wirings 138, 139 for supplying drive signals to two cooling fans 25 are connected. The main substrate 22 and the HDD substrate 23 are interconnected through connection wiring 144 between a connector 142 mounted on the back side of the main substrate 22 and a connector 143 on the front side of the HDD substrate 23 so that they can communicate with each other. The main substrate 22 is equipped with a direct current (DC) IN jack 6, USB connector 7, AVOUT jack 8 for AV output, and headphone jack 10. The HDD substrate 23 is equipped with a switch 145 for resetting the system. Connection wiring 146 drawn out from the battery pack 27 is connected to a connector 147 mounted on the front side of the main substrate 22. The HDD 24 is electrically connected to the HDD substrate 23 through a connector 148 mounted on the back side of HDD substrate 23.

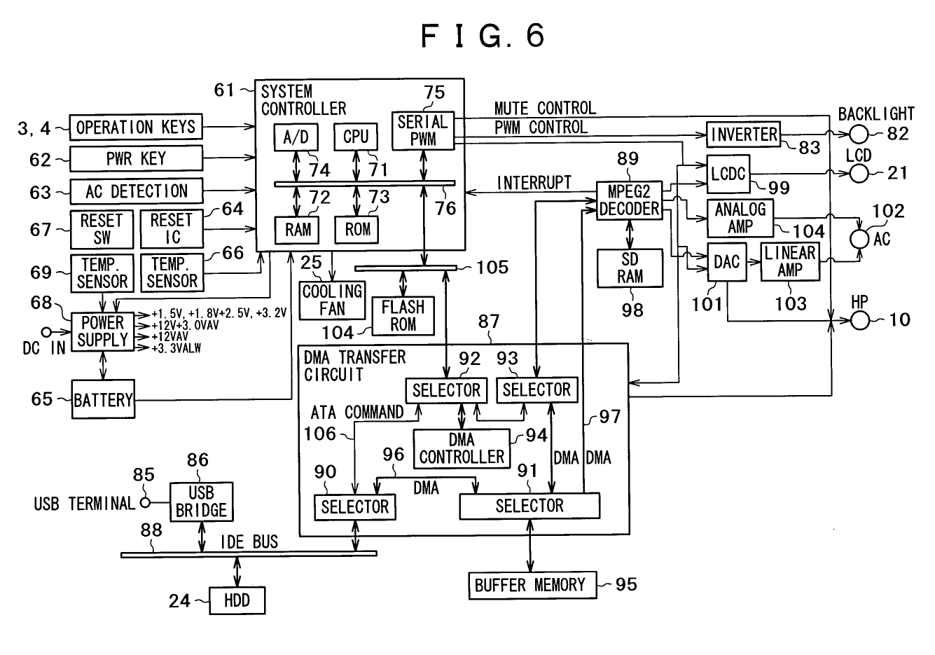

Next, the electrical structure of the PDH 100 is discussed, using FIG. 6. This figure mainly depicts the arrangement of the circuits installed on the main substrate 22.

In this figure, the system controller 61 monitors the operations of the multi-selector 3 and operation buttons 4, the PWR key 62 operation, connection to alternating current (AC) power supply (AC detection) 63, the output of a reset IC 64, the voltage of a battery 65, and a temperature sensor 66, etc. and performs processing according to the result of the monitoring. The reset IC 64 generates a reset signal when a reset SW 67 is operated.

When the system controller 61 detects that the PWR key 62 is pressed, it performs system boot processing and initializes the component devices read for operation. It exerts control to turn the power-on indicator 51 on. When it detects that the PWR key 62 is pressed during system operation, it performs system end processing.

When the system controller 61 receives a reset signal from the reset IC 64, it performs reset processing, that is, boot processing following end processing.

When the system controller 61 detects connection to AC power supply (AC detection) 63, it exerts control of a power supply circuit 68 and charging the battery 65. The power supply circuit 68 is arranged to be turned off automatically, according to the output of the temperature sensor 69 placed near it, for example, when a high temperature exceeding a set temperature is detected.

The system controller 61 calculates remaining power of the battery 65, based on the result of the battery power monitoring, and controls the display of remaining battery power on the display screen.

The system controller 61 controls the revolution speed of the cooling fans 25, based on the output of the temperature sensor 66. That is, it exerts the control to boost the cooling power in proportion to temperature rise.

The system controller 61 also monitors the operations of the multi-selector 3 and the operation buttons 4 and performs event processing corresponding to a key command issued by operating any key or button.

The system controller 61 comprises, but not limited to, a central processing unit (CPU)) 71, random access memory (RAM) 72, read only memory (ROM) 73, A/D conversion circuit 74, and serial Pulse Width Modulation (PWM) control circuit 75, which are interconnected through a bus 76. Using the RAM 72 for a working area, the CPU 71 performs kinds of arithmetic processing and control by firmware stored in the ROM 73. The A/D conversion circuit 74 converts analog values obtained as the result of monitoring the above-mentioned operations of the multi-selector 3 and operation buttons 4, PWR key 62 operation, connection to AC power supply (AC detection) 63, reset IC 64 output, battery 65 voltage, and temperature sensor 66, etc. to digital values. The serial PWM control circuit 75 supplies the inverter 83 with PWM signals that control muting the headphone 81 and the backlight 82 brightness.

A USB bridge 86 connected to a USB terminal 85, a HDD 24, and a Direct Memory Access (DMA) transfer circuit 87 are interconnected through an Integrated Drive Electronics (IDE) bus 88. Data such as moving picture streams transferred from a PC connected to the USB terminal 85 goes through the USB bridge 86 and the IDE bus 88 to the HDD 24 where the data is recorded.

The DMA transfer circuit 87 transfers data read from the HDD 24 to a MPEG2 decoder 89. The DMA transfer circuit 87 comprises four selectors 90, 91, 92, 93, and a DMA controller 94. The first selector 90 is for selecting data on the IDE bus 88 and places the DMA transfer circuit 87 in connection to the IDE bus 88, according to an AT Attachment (ATA) command that the system controller 61 issues to access the HDD 24. The first selector 90 is connected via a first DMA transmission path 96 to the second selector 91 connected to a buffer memory 95. Thus, the data extracted from the IDE bus 88 is transferred through the first DMA transmission path 96 and the second selector 91 to the buffer memory 95.

For data transfer from the HDD 24 to the buffer memory 95, the system controller 61 controls the timing of ATA command output to the first selector 90 so that data reading from the HDD 24 will be performed intermittently. In particular, the ATA command is issued from the system controller 61 to the first selector 90 so that, for example, one block of a moving picture stream for a given time of playback will be read from the HDD 24 and transferred to the buffer memory 95 and the next block of the moving picture stream for the given time of playback will be read when the buffer memory 95 becomes empty. Consequently, access to the HDD 24 takes place intermittently and this can help reduce heat generation in the HDD 24 and power consumption.

Once the moving picture stream for the given time of playback has been stored in the buffer memory 95, the data corresponding to the part of the moving picture is read from the buffer memory 95 by the second selector 91 and transferred to the MPEG2 decoder 89 through a second DMA transmission path 97 between the second selector 91 and the MPEG2 decoder 89. The MPEG2 decoder 89 is a circuit to decode MPEG2-coded moving picture streams by hardware. A SDRAM 98 is a randomly accessible memory that is used by the MPEG2 decoder 89 as its working area.

The moving picture data that is output from the MPEG2 decoder 89 is sent to an LCD controller 99 that controls driving the LCD 21 and the moving picture is reproduced on the LCD under the control of the LCD controller 99. Meanwhile, audio data output from the MPEG2 decoder 89 is converted into analog signals by a D/A converter 101 and then sent to a headphone connected to a headphone terminal 10. An external television set or the like can be connected to an AVOUT terminal 102. When an external television set is connected to the AVOUT terminal 102, the analog signals from the D/A converter 101 are amplified to a required level by a linear amplifier 103.

A third selector 92 in the DMA transfer circuit 87 communicates with a bus 105 to which the system controller 61 and a flash ROM 104 is connected. The third selector 92 extracts an ATA command issued from the system controller 61 from the bus 105 and sends the ATA command to the first selector 90 through a control line 106.

Data for read only such as bitmaps and character codes constituting a list of titles, menus, setting screens, and the like will be stored on the HDD 24. When reading some bitmap and character code data from the HDD 24, the system controller 61 sends a read access request on the data to the DMA controller 94 via the third selector 92. Upon receiving this request, the DMA controller 94 makes the DMA transmission path 96 available for communication between the first selector 90 and the second selector 91 and controls a fourth selector 93 to make a third DMA transmission path 107 available for communication between the second selector 91 and the MPEG2 decoder 89.

Character code once stored together with a bitmap in the buffer memory 95 after being read from the HDD 24 is sent via the second selector 91, third selector 92, and bus 105 to the system controller 61. The system controller 61 reads bitmap data corresponding to the character code from the flash ROM 104 and returns it to the third selector 92. The DMA controller 94 exerts control to send the bitmap data corresponding to the character code, returned from the system controller 61, from the third selector 92 to the fourth selector 93, combine this bitmap data with the bitmap that has been read from the buffer memory 95 via the second selector 91, and output the combined bitmap to the MPEG2 decoder 89.

The third DMA transmission path 107 that is used for bitmap transmission has a broader bus width than the second DMA transmission path 97. For example, the second DMA transmission path 97 consists of eight data lines and four control lines, whereas the third DMA transmission path 107 consists of 16 data lines, 24 address lines, and three control lines. This arrangement aims to minimize the difference in display speed that the user feels between a playback of moving picture streams and presentation of information reproduced from bitmaps.

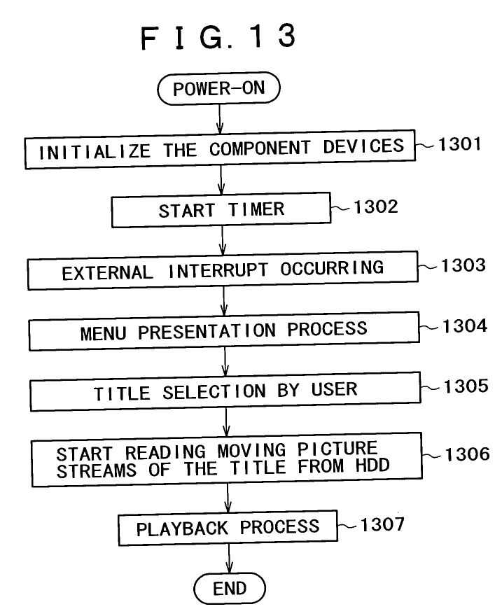

Next, the operation of the PDH 100 and operation screens are discussed. FIG. 13 illustrates the procedure steps from power-on to the start of moving picture playback.

When the PWR key of the PDH 100 is pressed by the user, the system controller 61 detects that the PWR key is pressed and initializes the component devices, according to the firmware stored in the ROM 73 (step 1301). Following this, the internal timer is started (step 1302). Then, transfer of moving picture streams from the PC, being connected to the PDD 100 via the USB connection, to the PDH 100 starts. When the transfer is completed, the PDH 100 receives a transfer complete notification from the PC as an external interrupt (step 1303). When the PDH 100 receives the external interrupt, it begins a menu presentation process of creating and displaying menus on the display screen (step 1304).

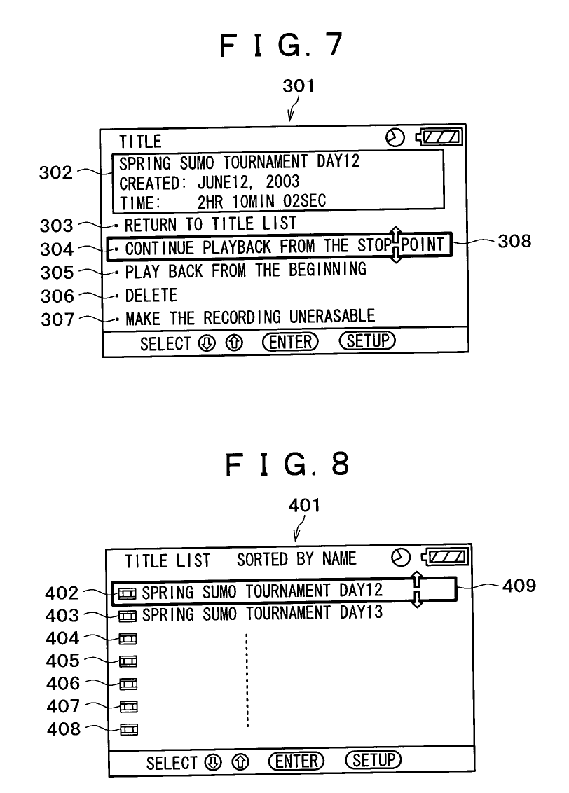

First, an action menu 301 like the one that is shown in FIG. 7 is displayed. On this action menu 301 screen, information relevant to a moving picture stream 302 comprising, but not limited to, the title of the moving picture stream that was played back last, date/time of creation, and picture recording time, and the items of selectable actions 303 to 307 are displayed. The actions comprise, but not limited to, “Return to Title List,” “Continue Playback from the Stop Point,” “Play Back from the Beginning,” “Delete,” and “Make the Recording Unerasable.” The focus 308 is positioned on one of these items 303 to 307 and the user can move the focus 308 position up and down freely by operating the menu/select key 32 of the multi-selector 3. The initial position of the focus 308 is always on the item “Continue Playback from the Stop Point,” so that the user can immediately start to view the playback of the moving picture stream from the last stop point without moving the focus 308. That is, after the action menu 301 appears immediately following the system boot, the user can view the playback of the moving picture stream from the last stop point of playback by pressing the ENTER key 31 of the multi-selector 3 straightforwardly.

When the user moves the focus to the item “Return to Title List” and presses the ENTER key 31 of the multi-selector 3, a title list 401 like the one that is shown in FIG. 8 appears, replacing the action menu 301. In this title list 401, all the titles of moving picture streams recorded on the HDD 24 of the PDH 100 are displayed in items 402 to 408. The focus 409 is positioned on one of these title items 402 to 408 and the user can move the focus 409 position up and down freely by operating the menu/select key 32 of the multi-selector 3. The initial position of the focus 409 is always on the title item that was played back last, so that the user can recognize the last viewed title. By operating the menu/select key 32 to move the focus to a title item that the user wants to view in the title list 401 and pressing the ENTER key 31, the user can view another title.

Now returning to the flowchart of FIG. 13, when a title that the user wants to view is selected by the user (step 1305) in the way described above (step 1305), the device starts reading the moving picture stream of the title from the HDD 24 (step 1306). Then, the device performs the playback process of the moving picture stream read from the HDD 24 (step 1307). Specifically, the moving picture stream read from the HDD 24 is DMA transferred and buffered into the buffer memory 93 and, then, DMA transferred to the MPEG2 decoder 89 and decoded. The LCD controller 99 drives the LCD 21, based on the moving picture data output from the MPEG2 decoder 89, and thereby the moving picture is displayed on the LCD 21 screen. Meanwhile, the audio data decoded by the MPEG2 decoder 89 is converted into analog signals by the D/A converter 101 and sent to the headphone connected to the headphone terminal 10 (step 1307).

When the user selects the item “Play Back from the Beginning” 305 in the action menu 301, the moving picture stream of the title that was played back last is played back from the beginning.

When the user selects the item “Delete” 306 in the action menu 301, the moving picture stream of the title that was played back last is removed from the HDD 24. That is, for example, the moving picture stream of a title that was viewed to the end can be removed from the HDD 24 by straightforward operation.

When the user selects the item “Make the Recording Unerasable” 307 in the action menu 301, the presented title's moving picture stream recorded on the HDD 24 is protected so it cannot be removed from the HDD 24.

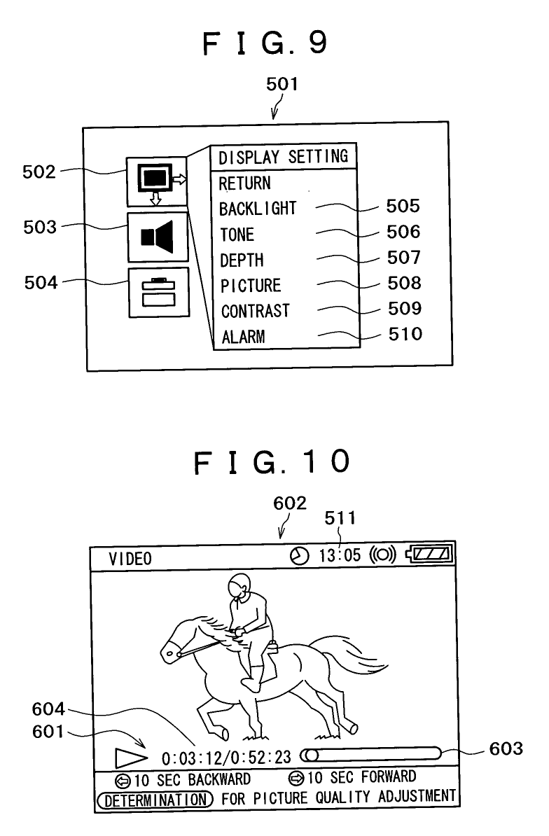

Next, the environment setting screen is discussed. FIG. 9 shows an example of the environment setting screen 501. Bringing up this environment setting screen 501 can be performed by pressing the SETUP button 41, for example. On the environment setting screen 501, various visual settings and various audio settings can be performed. On this environment setting screen 501, for example, a visual setting icon 502, audio setting icon 503, and miscellaneous icon 504 are displayed. One of the icons 502 to 504 can be selected by moving the focus with the menu/select key 32 and the ENTER key 31. The visual setting items comprise, but not limited to, backlight brightness adjustment 505, tone 506, depth 507, picture 508, contrast 509, and alarm 510. Selecting any of the setting items can be performed by moving the focus with the with the menu/select key 32 and the ENTER key 31.

The alarm 510 is a timer-based alarm function. Remaining time of playback that can arbitrarily be set by the user is set on the timer. As is shown in FIG. 10, the remaining time 511 is always shown at a part of the screen during the playback of moving picture stream. When the remaining time becomes zero, for example, an alarm sound is output overlapping the audio output accompanied by the moving picture playback. Time of day clock indication may be present on a TV broadcast. When the user views the playback of the broadcast recording with the PDH 100, there is a possibility that the user mistakes the clock indication for the present time and might be liable to miss his or her stop on the train or the like. By using the above alarm function, the user will be alerted of the elapse of the time set on the timer when being involved in viewing moving picture content and this function helps prevent the user from missing his of her stop on the train or the like.

FIG. 10 shows an example of the screen 602 that presents the elapsed (remaining) time 601 of playback of moving picture stream. This elapsed (remaining) time 601 of playback of moving picture stream can be shown numerically 602 and in a visual indicator 603 on the moving picture stream being played back by pressing the DISPLAY button 42, for example.

During the playback of moving picture stream, it is possible to fast-forward and rewind the playback and increase and decrease the sound volume by operating the playback control key 33. The playback control key 33, as shown in FIG. 2, is arranged to fast-forward the playback by pressing its right position and rewind the playback by pressing its left position. When the right position of the playback control key 33 is pressed once, a fast-forward by a predetermined, fixed time period (e.g., 15 seconds) is executed. By keeping pressing this position longer than a given time period, a continuous fast-forward is executed as long as it is pressed. When the right position keeps pressed further for a given time period after the start of continuous fast-forward, the fast-forward speed will be boosted. In particular, the first stage of continuous fast-forward is performed at normal speed multiplied by 15. The next stage of fast-forward is performed at normal speed multiplied by 60. When the left position of the playback control key 33 is pressed once, a rewind by a predetermined, fixed time period (e.g., 15 seconds) is executed. By keeping pressing this position longer than a given time period, a continuous rewind is executed as long as it is pressed. When the left position keeps pressed further for a given time period after the start of continuous rewind, the rewind speed will be boosted. In particular, the first stage of continuous rewind is performed at normal speed multiplied by 15. The next stage of rewind is performed at normal speed multiplied by 60.

Next, a stationary electronic device from which data such as moving picture streams is transferred to the PDH 100 discussed hereinbefore in the present embodiment is discussed.

In the present embodiment, a personal computer (PC) is applied as the electronic device. The following description of the embodiment assumes that moving picture streams of a TV program or the like, recorded in the PC, are transferred to the PDH 100.

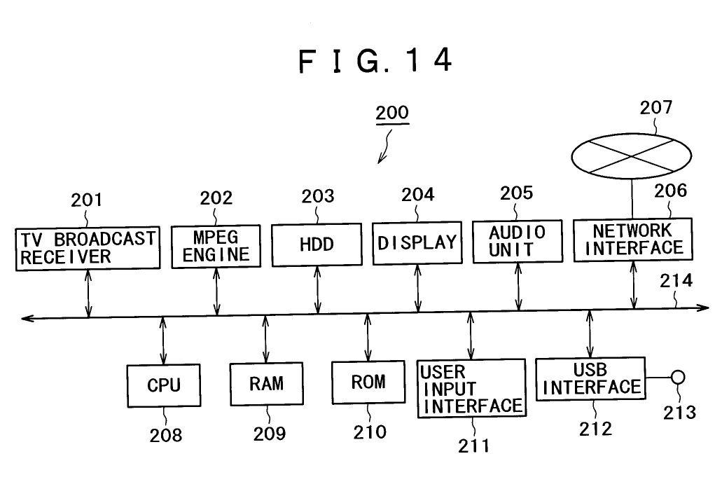

FIG. 14 is a block diagram showing the PC 200 configuration according to one embodiment of the present invention. As shown in this figure, the PC 200 comprises a TV broadcast receiver 201, MPEG engine 202, HDD 203, display 204, audio unit 205, network interface 206, CPU 208, RAM 209, ROM 210, user input interface 211, and USB interface 212, which are interconnected via a bus 214.

The TV broadcast receiver 201 comprises, but not limited to, an antenna, tuner, and decoder that are not shown. Analog and digital broadcasts broadcasted from a broadcasting station are received by the antenna and a channel is selected by the tuner under the control of the CPU 208. The digital and analog broadcasts on the selected channel are converted into bit streams that are then sent to the MPEG engine 202.

If the device is arranged to receive content distributed by a cable television provider, the TV broadcast receiver 201 configuration may not include the antenna.

The MPEG engine 202 comprises, but not limited to, a MPEG encoder and MPEG decoder. The MPEG encoder compresses and encodes non-MPEG2 format data into MPEG2 format and the MPEG decoder decodes bit streams into video.

The HDD 203 stores moving picture streams recorded corresponding to TV program data received and converted into bit streams and also stores moving picture streams downloaded via the network interface 206.

The display 204 to which video signals decoded by the MPEG decoder are output and, specifically, may be embodied in, e.g., a Cathode Ray Tube (CRT), Liquid Crystal Display (LCD), Plasma Display Panel (PDP), or Organic Electroluminescence (OE).

The audio unit 205 comprises, but not limited to, amplifiers and speakers, amplifies audio signals decoded by the MPEG decoder by the amplifiers and audibly outputs the amplified signals from the speakers.

The network interface 206 may be embodied in, e.g., an analog modem, Local Area Network (LAN) interface, Integrated Services Digital Network (ISDN) interface, Asymmetric Digital Subscriber Line (ADSL) interface, Fiber-To-The-Home (FTTH) interface, Bluetooth interface, or FOMA (W-CDMA) interface, and enables communication with a network 207.

The CPU 208 performs kinds of arithmetic processing and control by firmware stored in the ROM 210, using the RAM 209 for a working area.

The RAM 209 is a randomly readable and writable, high-speed memory to which video information, audio information, data, software, etc. may be stored temporarily, as required, and aids smoother control of the PC 200.

The ROM 210 is a read only or readable and writable nonvolatile storage device.

The user input interface 211 may specifically consist of, e.g., a jog dial, plain keyboard, Infrared (IR) remote controller, and pushbuttons.

The USB interface 212 is connected to a USB terminal 213 and enables transfer of moving picture streams stored on the HDD 203 to the above PDH 100 via the USB terminal 213.

Next, applications required to transfer moving picture streams stored on the above HDD 203 to the above PDH 100 in the present embodiment are discussed.

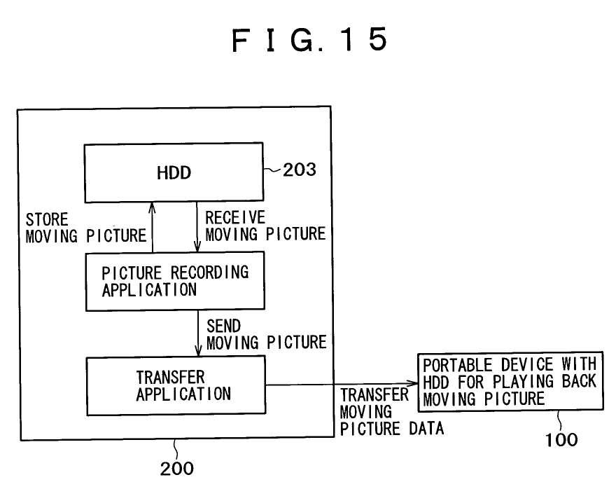

FIG. 15 is a diagram showing a simplified structure of a transfer system in the present embodiment.

As shown in this figure, in the present embodiment, software installed on the PC 200 includes a picture recording application for recording moving picture streams of a TV program or the like received by the TV broadcast receiver 201 and a transfer application for transferring the moving picture streams recorded by the picture recording application to the PDH 100.

The picture recording application stores moving picture streams onto the HDD 203 and, from the picture recording application, the transfer application receives moving picture streams that the picture recording application has retrieved from the HDD 203 and transfers the moving picture streams to the above PDH 100.

First, the picture recording application is explained. The picture recording application allows for regular time booking in which a program that is broadcasted for a same time zone, e.g., everyday or every week is booked to be recorded as well as plain booking in which a single-shot program at any day and time is booked to be recorded.

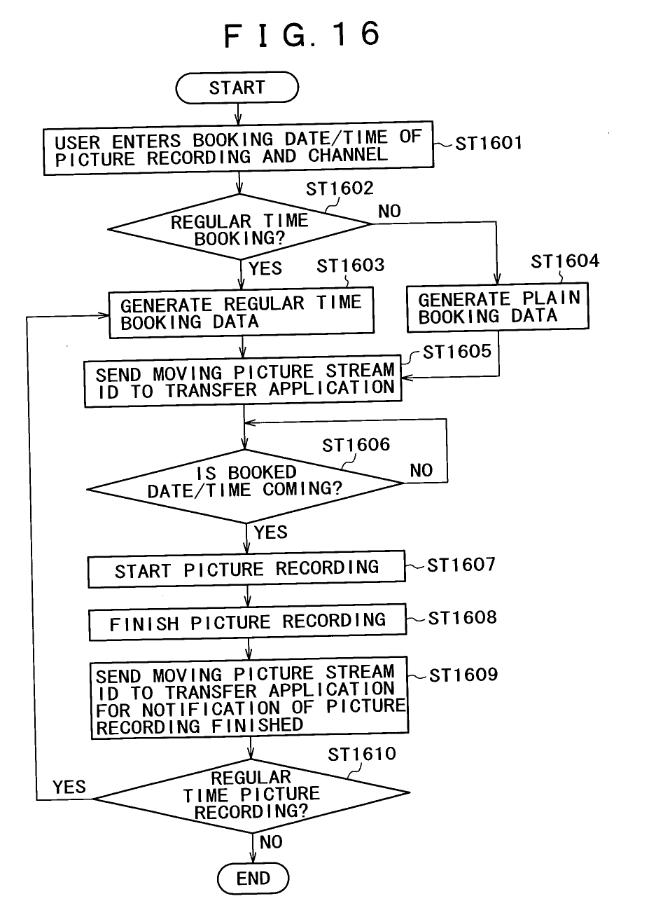

FIG. 16 is a flowchart illustrating the operation of recording moving picture streams by the picture recording application. As shown in this figure, first, the user enters booking date/time of a TV program to be recorded and its channel (ST 1601). At this time, if the user wants to do regular time booking, the user will specify the program and enter regular time booking specifics. It is determined whether the program booking input is for plain booking or regular time booking (ST1602). If the input is regular time booking (YES at ST1602) for example, weekly program booking, the picture recording application generates booking data for recording the program on the same time zone every coming week (ST1603). If the input is plain booking (No at ST1602), the picture recording application generates booking data for the program only (ST1602). As booking data, the date/times of start and end of the booked program broadcast, title, and moving picture stream ID as information to identify the moving picture stream of the program recorded are generated and stored. For regular time booking, a flag to indicate booking the program to be recorded at regular time is added to the above data.

Then, the picture recording application sends the moving picture stream ID out of the above booking data to the above transfer application (ST1605). At this time, the transfer application stores the received moving picture stream ID if necessary, detail of which will be described later. The picture recording application determines whether booked date/time that was set for recording is coming (ST1606). At the date/time, when the TV broadcast receiver 201 receives the TV program, the application starts picture recording (ST1607) and finishes the picture recording at the end time of the program (ST1608). When the picture recording finishes, the picture recording application sends the moving picture stream ID to the transfer application to notify the transfer application that the picture recording of the program has finished (ST1609). Then, it is determined whether the recording is a regular time booked program (ST1610). If the recording is a regular time booked program (YES at ST1610), the next picture recording process is repeated. If the recording is a plain booked program (NO at ST1610), the operation terminates.

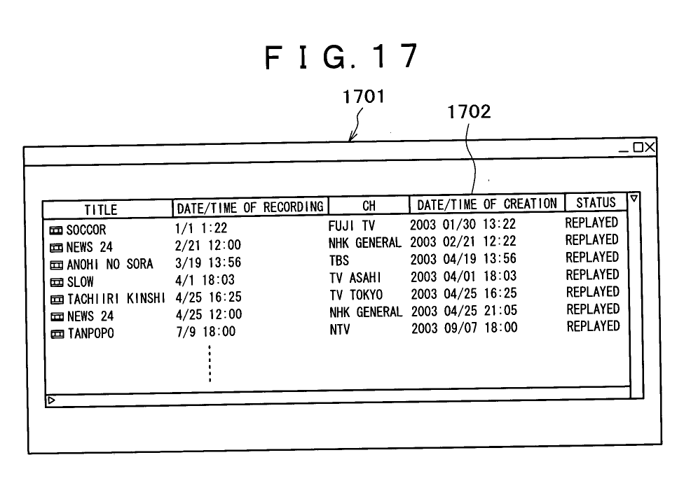

The picture stream of the recorded program is stored onto the HDD 203. Programs booked for recording and recorded programs are managed in a recording list box 1702 that is displayed in a window 1701 of the picture recording application, as is shown in FIG. 17. In the recording list box 1702, program titles, channels, date/time of broadcast, status “recorded/not recorded,” date/time when the moving picture stream of the program was created if the status is “recorded” are presented in order of time when the data was recorded/booked from top down, for example.

Next, the transfer application for transferring the moving picture stream of a program recorded by the above picture recording application to the above PDH.

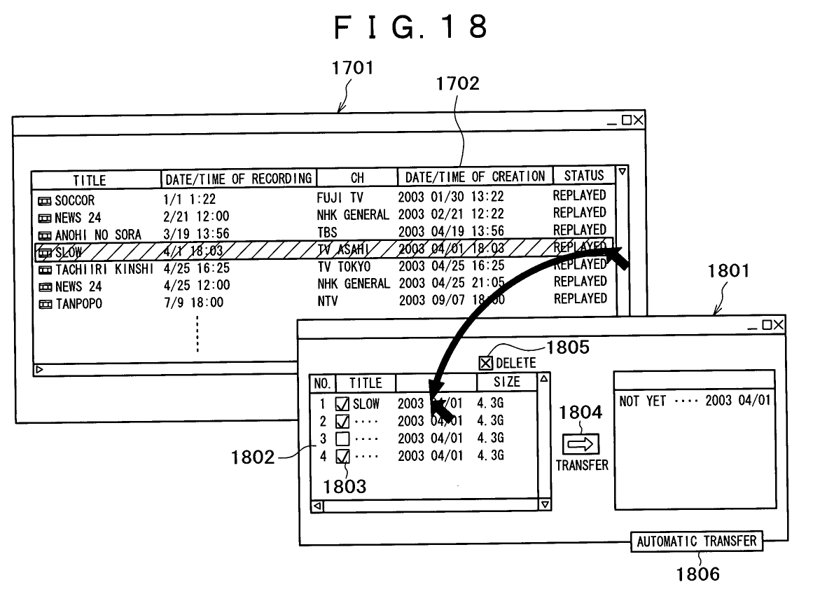

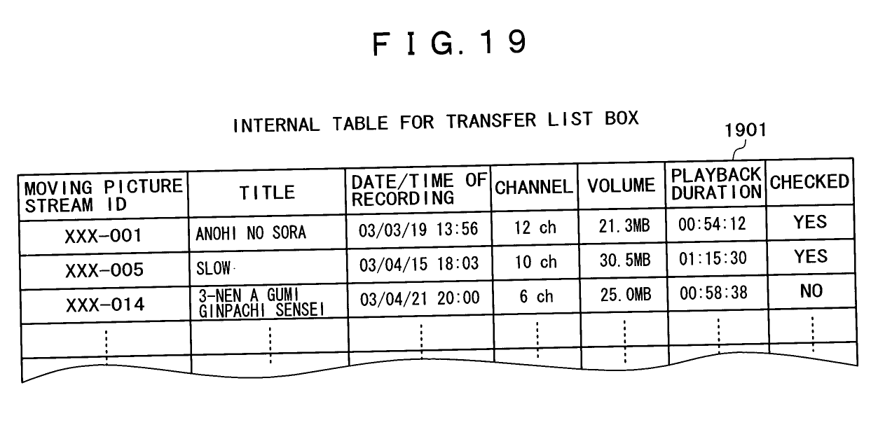

FIG. 18 shows exemplary windows that are displayed when transfer of moving picture streams is performed using the above two applications.

When transfer of moving picture streams is performed, the user first activates the picture recording application and transfer application and brings up the window 1701 that presents the recording list box 1702 and a window 1801 of the transfer application, as shown in FIG. 18. Then, the user drags a desired moving picture stream from the recording list box 1702 and drops it into a transfer list box 1802 in the window 1801 of the transfer application, using the mouse. Thereby, information relevant to the moving picture stream such as the title of the moving picture stream, channel, date/time of recording, and size is presented in the transfer list box 1802. In the transfer list box, checkboxes 1803 are provided per item of moving picture stream. For a moving picture stream that the user wants to transfer, the user must check its checkbox 1803 with the mouse and click the transfer button 1804 with the mouse. At this time, if the PDH 100 is connected to the PC 200, the transfer of the moving picture stream from the PC 200 to the PDH 100 immediately begins. When the user clicks the transfer button 1804 with the mouse, if the PDH 100 is not connected to the PC 200, the transfer of the moving picture stream begins as soon as the PDH 100 is connected. The connection between the PC 200 and the PDH 100 is made via a USB cable from the USB interface 212 and USB terminal 213, for example.

Moving picture streams that are stored in the PC may have different formats such as Audio Video Interleaved (AVI) and Windows (a registered trademark of Microsoft Inc.) Media Video (WMV). The PDH 100 decodes MPEG2 format moving picture streams for playback by its specifications. Before transferring moving picture streams from the PC to the PDH 100, the transfer application determines whether the moving picture stream to be transferred is MPEG2 format. If the stream is a non-MPEG2 format, the format is automatically converted to MPEG2 by the MPEG engine 202 and the MPEG2 moving picture stream is automatically transferred.

Although the moving picture streams listed in the transfer list box 1802 will be transferred in order from top, it is possible to change the order of transfer by altering the check timings of the above checkboxes 1803. After selecting a moving picture stream that the user wants to delete, by clicking the delete button 1805, the selected moving picture stream can be deleted from the transfer list box 1802 and excluded from those to be transferred.

If the total amount of the moving picture streams set to be transferred is greater than free space of storage in the PDH 100, the volumes of the moving picture streams can be added one by one from top within the limit of the size of the free space of storage in the PDH 100. The thus limited quantity of moving picture streams can be transferred in order from the top of the list.

FIG. 19 shows an example of a transfer list table 1901 that is stored within the transfer application to manage the moving picture streams listed in the transfer list box 1802.

As shown in FIG. 19, in the transfer list table 1901, for each moving picture stream to be transferred, its ID, title, date/time of recording, channel name, stream volume, playback duration, checkbox, etc. are managed. The moving picture stream ID is the ID that was previously assigned to the booked program for recording when the picture recording application executed the booking for recording. When the user dragged a moving picture stream from the above recording list box 1702 of the above picture recording application and dropped it into the transfer list box, the transfer application obtained the moving picture stream ID together with other information such as the title and stored the stream ID and related information. Because all moving picture streams are assigned their IDs, each moving picture stream can be identified by its ID. When transferring a moving picture stream to the PDH 100, the transfer application retrieves the moving picture stream from the HDD 203, according to the above moving picture stream, and transfers the stream.

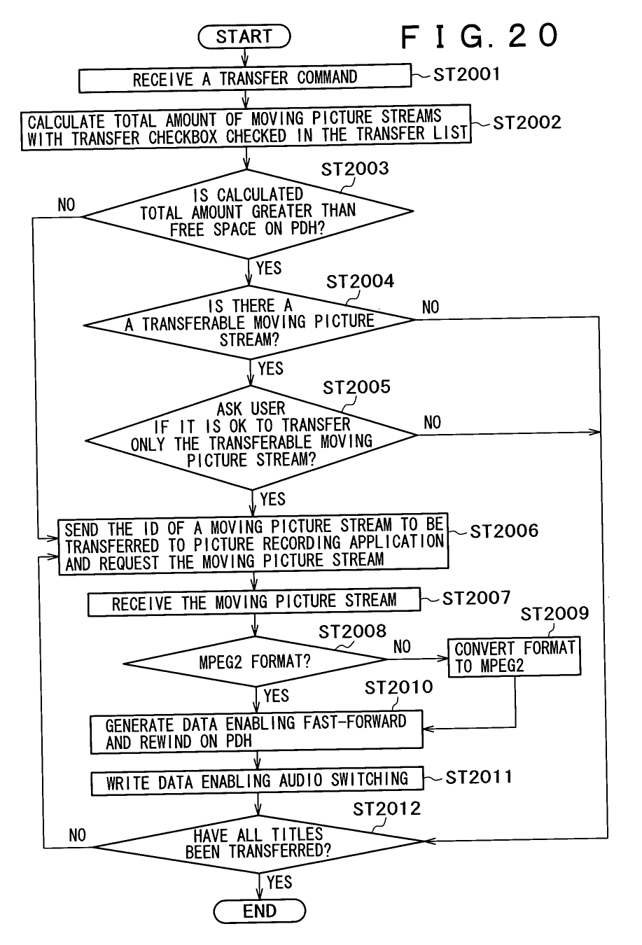

Next, the operation in which the above transfer application transfers moving picture streams will be described more fully, using a flowchart shown in FIG. 20.

As shown in FIG. 20, the transfer application first receives a transfer command when the user clicks the above transfer button 1804 with the PC 200 connected to the PDH 100 (ST2001). The transfer application calculates the total amount of the moving picture streams with their checkboxes 1803 checked in the transfer list box 1802, in short, the moving picture steams set to be transferred (ST2002). Since the volume of each moving picture stream is stored in the above internal table 1901 for the transfer list box, the above calculation can be executed. Meanwhile, the free space of the HDD 24 in the PDH 100 is also calculated. The application compares the total amount of the moving picture streams set to be transferred with the free space of the HDD 24 (ST2003). As the result of the comparison, if the total amount of the moving picture streams is smaller than the free space (NO at ST2003), the transfer application sends the IDs of the moving picture streams set to be transferred to the picture recording application and requests the moving picture streams (ST2006). Otherwise, if the total amount of the moving picture streams is greater than the above free space (YES at ST2003), the transfer application checks the volume of each moving picture stream set to be transferred from the top of the list and determines whether there is a transferable moving picture stream (ST2004). That is, by checking the volume of each moving picture stream set to be transferred in order from the top of the list, if a moving picture stream smaller than the above free space is found, the transfer application asks the user if it is OK to transfer only the transferable moving picture stream (ST2005). If the user inputs a “not to transfer” command (NO at ST2005), the transfer process terminates. If the user inputs the transfer command, the transfer application sets one or more transferable moving picture streams to be transferred within the limit of the size of the above free space and sends the ID or IDs of the one or more transferable moving picture streams to the picture recording application (ST2006). The picture recording application retrieves the requested moving picture streams from the HDD 203, according to the moving picture stream ID(s) received from the transfer application and returns the moving picture stream data to the transfer application. Having received the moving picture stream data (ST2007), the transfer application determines whether the moving picture streams are MPEG format (ST2008). If the format is non-MPEG-2, that is, AVI, WMV, etc. (NO at ST2008), converting the moving picture streams to MPEG2 format is executed (ST2009). Next, the transfer application generates data enabling fast-forward and rewind of the moving picture streams on the PDH 100 after the streams are transferred (ST2008). Specifically, the application extracts video packets from the MPEG2 format moving picture streams and registers the actual addresses of I picture start and end positions included in Group of Pictures (GOP) in the packets. As the PDH 100 obtains those actual addresses, it becomes able to fast-forward and rewind the playback of video information in the moving picture streams. Then, the transfer application writes data enabling audio switching on the PDH 100 (ST2011). Specifically, the application extracts audio packets from the MPEG2 format moving picture streams, reads the headers of the packets, and obtains audio output mode from the bit value indicating audio output mode (stereo/monaural) in the headers 123. Thereby, the PDH 100 becomes able to fast-forward and rewind the playback of audio information in the moving picture streams. The operation is repeated for all moving picture streams set to be transferred (NO at ST1012). When all the moving picture streams are transferred (YES at ST1012), the transfer process terminates.

The described operation is performed when the user manually transfers desired moving picture streams. Some moving picture stream may be several gigabytes in size and it may take a considerable time to transfer all object moving picture streams manually.

In view hereof, this transfer application is provided with an automatic transfer function that executes transfer automatically, if preset, without the need to click the above transfer button 1804.

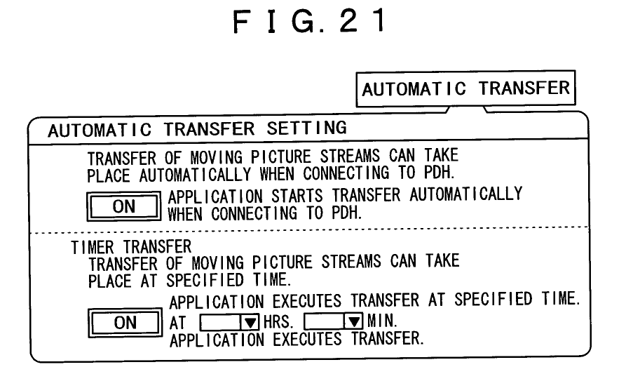

This automatic transfer function can be used by clicking the automatic transfer button 1806 in the window 1801 of the transfer application with the mouse. Then, a window like the one that is shown in FIG. 21 appears, allowing the user to set automatic transfer to start automatically when the PC 200 is connected to the PDH 100 or set time to start automatic transfer (timer transfer). The user may choose either method. In the case of timer transfer, the user must enter desired time to start transfer and fix.

In the case of automatic transfer to take place when connecting to the PDH 100, immediately at the detection of the connection made, the transfer application proceeds to transfer the moving picture streams whose recording has finished among those listed in the transfer list box 1802 in order from top. In the case of timer transfer, the application stores the time to start transfer that was specified by the user, compares this time with the clock time, and, when the specified time comes, transfers the streams from the PC 200 to the PDH 100 in the same way.

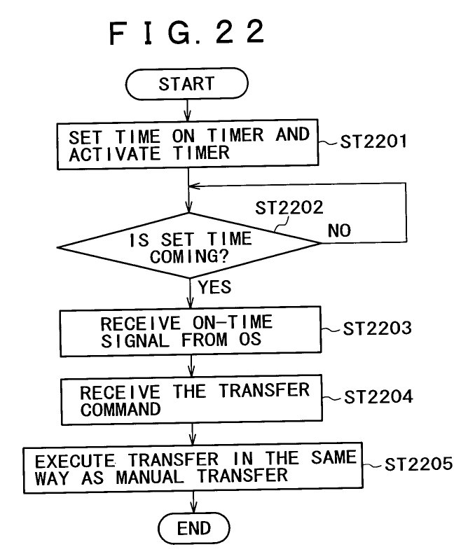

FIG. 22 is a flowchart illustrating an operation in which automatic transfer is performed by timer transfer. As illustrate in this figure, first, the transfer application sets time on the timer as specified by the user and activates the timer (ST2201). Then, the application determines whether the set time is coming (ST2202). When the set time is coming (YES at ST2202), the application receives an on-time signal from the operating system (OS) (ST2203). Upon receiving the transfer command (ST2204), the application proceeds to transfer in the same way as for manual transfer (ST2205).

Through the foregoing operation, the PC can execute automatic transfer according to user preference, as the user may preset automatic transfer or timer, but need not click the transfer button 1804 in the window 1801 of the transfer application. Thus, the usability is improved.

By the way, among the moving picture streams managed by the above picture recording application, the streams whose recording has not finished yet cannot be transferred before the recording finishes. It is troublesome for the user to wait until the recording finishes, activate the transfer application whenever a new recording is made, and start the transfer process.

In view hereof, this transfer application is provided with a transfer booking function that enables advanced booking of transfer of moving picture streams whose recording has not finished and setting automatic transfer to the PDH 100 to take place later as soon as the recording finishes.

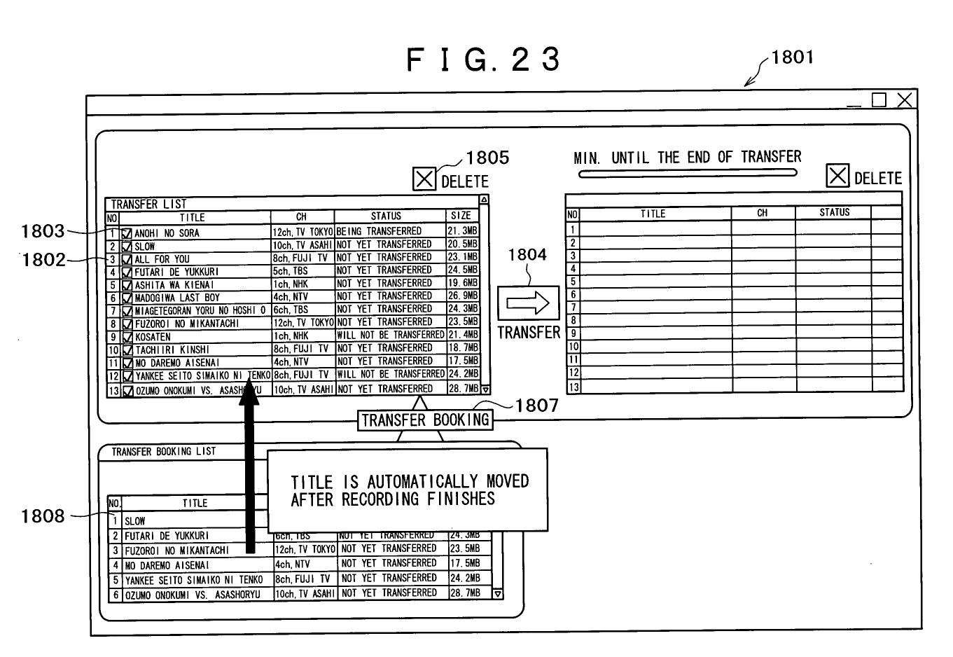

FIG. 23 shows a window example that is displayed when the transfer booking is performed in the transfer application.

To make transfer booking, as shown in FIG. 23, when the user clicks the transfer booking button 1807 in the window 1801 of the transfer application with the mouse, a transfer booking list box 1808 appears. By dragging a moving picture stream that the user wants to book for transfer from the window 1801 and dropping it into the transfer booking list box 1808 in the same manner as described for the above FIG. 18, the user can make the booking transfer list.

The moving picture streams listed in the transfer booking list box 1808 will be moved to the transfer list box 1802 automatically when their recording finishes. After that, the user can start manual transfer by clicking the transfer button 1808 or set automatic transfer to take place when connecting to the PDH 100 or automatic transfer by timer, as described above.

When moving picture streams are registered in the above transfer booking list box 1808, the transfer booking list box 1808 obtains all the same specifics other than “checkbox checked” as stored in the above transfer list table 1901 and retains and manages these specifics.

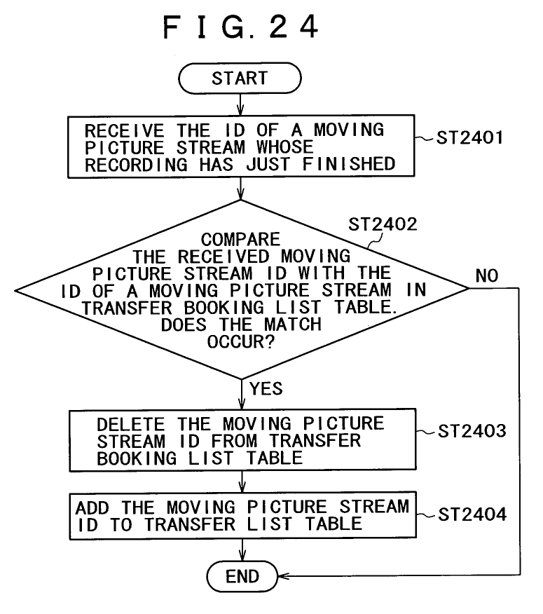

FIG. 24 is a flowchart illustrating an operation in which moving picture streams are moved from the above transfer booking list box to the above transfer list box.

As illustrated in FIG. 24, in the first step, when the picture recording application finishes the recording of a moving picture stream, the transfer application receives the ID of the moving picture stream whose recording has just finished from the picture recording application (ST2401). Then, the transfer application compares the received moving picture stream ID with the ID of each moving picture stream stored in the table of the above transfer booking list box 1808 (ST2402). If a match occurs, the application deletes the matched moving picture stream ID from the table of the above transfer booking list box 1808 (ST2403) and adds the moving picture stream ID to the table of the transfer list box. transfer. Thereby, the management data for the moving picture stream whose recording has just finished is moved from the transfer booking list box 1808 to the transfer list box 1802. Subsequently, the transfer of the above stream to the PDH 100 can be executed through the same process as described above.

In the transfer application, all moving picture streams that were booked for recording in the picture recording application can be registered to be transferred to the PDH 100. Herein, this function is referred to as an automatic registration function. As described above, when the picture recording application books a moving picture stream for recording, it sends the ID of the moving picture stream to the transfer application to notify the transfer application that the booking of the stream recording has been set. At this time, if automatic registration is set in the transfer application, the transfer application obtains the information relevant to the moving picture stream such as its title, channel, etc., based on its ID, from the picture recording application and adds the information to the transfer booking list box 1808. Thereafter, the stream management data is moved to the transfer list box 1802 in the same operation as described above and the stream is transferred.

Through the foregoing operation, even those moving picture streams that are booked, but have not been recorded yet can be transferred as soon as their recording finishes by using the above transfer booking function, avoiding trouble and time such as checking if recording has finished for each stream Especially by using the transfer booking function in combination with the timer-based automatic transfer function, transfer booking of moving picture streams that the user wants to transfer, but have not been recorded can be performed so that their automatic transfer will take place with the PC 200 connected to the PDH 100. Thereafter, the transfer can be executed without user operation. For example, booking and automatic transfer can be set so that a program will be recorded and automatically transferred to the PDH 100 during a night when the user is sleeping and the program can be played back on the PDH 100 when the user wakes up in the morning. Like this, transfer booking can be set so that automatic transfer will take place during a time zone when the user will not operate the PC and the usability for the user is improved remarkably.

By the way, the above picture recording application is capable of regular time booking in which a program that is broadcasted for a same time zone everyday or every week is booked to be recorded always and repeatedly as well as plain booking in which a program at any day and time is booked to be recorded. In conjunction with this regular time booking function, the transfer application has a function to automatically transfer the moving picture stream of a regular time booked program to the PDH. This function must be used with the above automatic registration function.

If regular time booking is set in the picture recording application, booking of date/time immediately before the start of broadcasting the program is set and a moving picture stream ID is assigned. Upon the finish of recording of the program thus set, next time booking is set and a new moving picture stream ID is assigned. This process is repeated. During this procedure, each time the picture recording application sets next time booking, it sends the moving picture stream ID of the booked program to the transfer application. Then, the transfer application obtains necessary information such as title, based on the moving picture stream ID, and adds the information to the transfer booking list box 1808. Thereafter, in conjunction with the automatic registration function, all regular time booked programs are transferred to the PDH 100.

With these functions, weekly booking of, for example, drama series that are broadcasted regularly once every week can be set to be performed by the picture recording application, so that the drama program recording can always be transferred to the PDH 100 and played back without additional user operation.

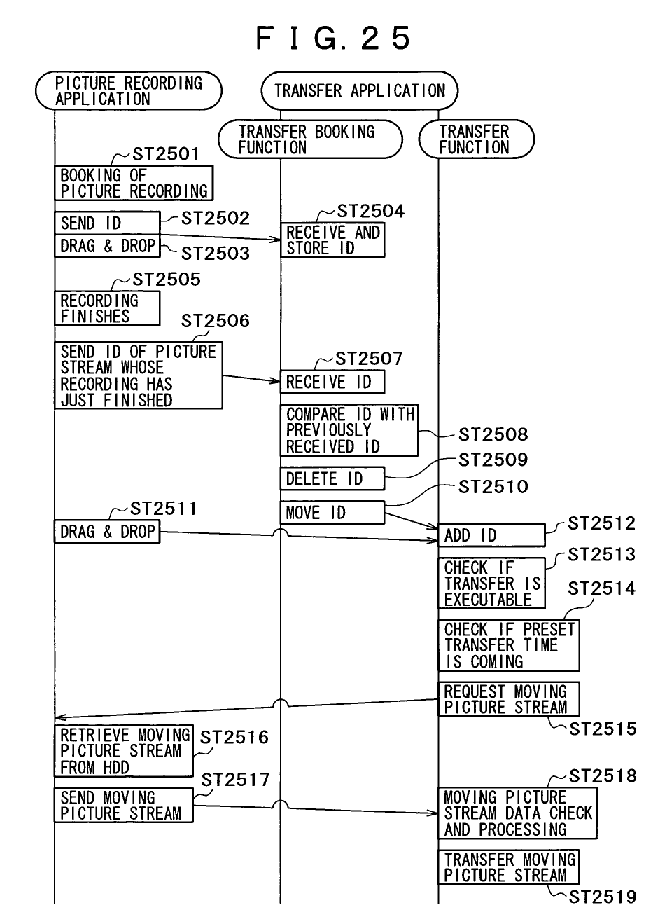

FIG. 25 is a sequence diagram that summarizes data transfer between the picture recording application and the transfer application in the process described hereinbefore.

As shown in FIG. 25, first, the picture recording application books a program to be recorded (ST2501) and generates and stores data such as moving picture stream ID. The picture recording application sends the moving picture stream ID to the transfer application (ST2502). At this time, if the above automatic registration function is set in the transfer application, this moving picture stream ID is added to the transfer booking list box 1808 by the transfer booking function (ST2504). If automatic registration is not set in the transfer application, the transfer application does no action on the moving picture stream ID. When the ID of a moving picture stream that has not been recorded is moved to the transfer application through drag and drop operation by the user (ST2503), the moving picture stream ID is added t the above transfer booking list box 1808. When moving picture stream recording finishes (ST2505), the picture recording application sends the stream ID to the transfer application to notify that the recording has finished (ST2506). Upon receiving the moving picture stream ID (ST2507), the transfer application compares this ID with the previously received moving picture stream ID (ST2508). As the result of the comparison, a match between the moving picture stream IDs occurs, the transfer application determines that the recording of the moving picture stream with the ID has finished, deletes the moving picture stream ID from the transfer booking list box 1808 (ST2509), and moves the stream ID to the transfer list box 1802 (ST2510). In the transfer list box, the moving picture stream ID is added (ST2512). When the user moves the recorded moving picture stream directly to the transfer list box 1802 (ST2511), the moving picture stream ID is added to the transfer list box 1802 without being registered in the transfer booking list box 1808. The transfer application checks if transfer is executable, that is, checks if the PC is connected to the PDH 100 (ST2513). If timer transfer is set, the transfer application checks if the preset transfer time is coming (ST2514). If these conditions are met, the transfer application sends the moving picture stream ID to the picture recording application and requests the moving picture stream data (ST2515). Having received the request, the picture recording application retrieves the moving picture stream data from the HDD 203, according to the moving picture stream ID (ST2516) and sends that data to the transfer application (ST2517). Having received the moving picture stream data, the transfer application checks if the data is MPEG2 format. If the data is a non-MPEG2 format, it is converted into MPEG2 format by the MPEG engine 202 and processing such as writing data enabling fast-forward and rewind and data enabling audio switching for playback on the PDH 100 is performed (ST2518) When all these operations finish, the moving picture stream is transferred to the PDH 100 (ST2519). The process is repeated until all moving picture streams are transferred.

This invention is not limited to the foregoing embodiments and various modifications may be made therein. For example, while an instance where video-recorded TV programs are transferred has been discussed in the foregoing embodiments, it is possible to apply this invention to transfer of contents that can be acquired from various media; e.g., booking to download and transfer so-called network movies and the like distributed on the Internet so that as soon as such movie content is downloaded, it will be transferred to the PDH 100.

While, in the foregoing embodiments, contents are transferred from the stationary recording/playback device to the PDH, using the USB interfaces and terminals, transfer technology involved in this invention is not so limited and can be modified in various forms. Not only wired, but also wireless interfaces may be used to transfer contents; e.g., Wireless Universal Serial Bus, Bluetooth, IEEE802.11b/g/a, etc. Furthermore, wireless communication using Ultra WideBand (UWB) that is being studied for future practical application and a high-speed wireless communication protocol that is discussed as IEEE802.11n may be used.

If wireless interfaces are used, it may also be preferable that the stationary recording/playback device periodically seeks for the presence of a portable terminal and, when a terminal is located, automatically transfers contents to the terminal.

It may preferable to transfer contents from the stationary recording/playback device to a plurality of PDHs. In such cases, it may be possible for the transfer application to set PDHs to be transferred so that the contents are transferred the PDHs per content. Contents identification information is managed together with information identifying the PDHs. The stationary recording/playback device compares the identification information of a PDH connected to it with identification information that is managed, associated with contents. Only the content with matched identification information is transferred.

In the foregoing embodiments, an instance where contents are transferred from the stationary recording/playback device to an external PDH has been discussed. However, contents may be transferred to a removable storage medium that is installed in the stationary recording/playback device; e.g., a removable hard disk, nonvolatile semiconductor memory, writable optical disk, etc.

While contents are stored on the HDD in the PDH in the disclosed embodiments, storage technology involved in this embodiment is not so limited and can be modified in various forms For example, a nonvolatile semiconductor memory may be used as storage means. Also, a removable storage medium may be used; e.g., an on volatile semiconductor memory card, writable optical disk, or removable hard disk drive.

The foregoing invention has been described in terms of preferred embodiments. However, those skilled, in the art will recognize that many variations of such embodiments exist. Such variations are intended to be within the scope of the present invention and the appended claims.

1. An electronic device comprising:
a recording setting means for setting content to be recorded at a first time;
a recording means for recording the content at the first time, according to setting by said recording setting means;
a transfer setting means for setting at least one content that was set by said recording setting means to be transferred to a terminal;
a detection means for detecting that the content set to be transferred has been recorded by said recording means; and
a transfer means for transferring the content detected to have been recorded to the terminal.

2. The electronic device according to claim 1,
wherein said transfer setting means can set the content to be transferred to the terminal at second time, and
wherein said transfer means transfers the content detected to have been recorded when the second time comes.

3. The electronic device according to claim 1, further comprising:
a confirmation means for confirming connection to the terminal, wherein said transfer means transfers the content to the terminal after the connection to the terminal is confirmed by said confirmation means.

4. The electronic device according to claim 1, further comprising:
means for comparing the total amount of a plurality of contents set to be transferred with free space of storage in a terminal to which the plurality of contents will be transferred, wherein, if the free space is less than the total amount, according to the result of the comparison, said transfer means transfers at least one content with the total amount being less than the free space to the terminal.

5. The electronic device according to claim 1, wherein said recording setting means can set content to be recorded periodically at the first time and at intervals of a given number of days.

6. An information transfer device that is electronic device which transfers content that was set to be recorded in a given storage area at a first time to a terminal, comprising:
a transfer booking means for booking the transfer of the content that was set to be recorded;
a first storage means for storing identification information for the transfer-booked content;
a comparison means which, when recording of the content has finished, compares the identification information of the content and the identification information stored by said storage means for a match;
a second storage means which, if the match of the identification information is judged by said comparison means, stores the identification information of the match; and
a transfer means which retrieves the content with the identification information stored by said second storage means from the given storage area, based on the identification information, and transfers the content to the terminal.

7. The information transfer device according to claim 6, further comprising:
a transfer setting means for setting the content to be transferred at a second time,
wherein, if the match of the identification information is judged by said comparison means on the second time, said second storage means stores the identification information,
if a mismatch of the identification information is judged by said comparison means on the second time, said second storage means will store the identification information only after the match of the identification information is judged.

8. The information transfer device according to claim 6, further comprising:
a confirmation means for confirming connection to the terminal, wherein said transfer means transfers the content to the terminal after the connection to the terminal is confirmed by said confirmation means.

9. The information transfer device according to claim 6, wherein said transfer means includes means for converting the content into a predetermined format if the content is not the predetermined format.

10. An information transfer method for transferring content that was booked and set to be recorded in a given storage area at a first time to a terminal, comprising:
a transfer booking step which books the transfer of the content that was set to be recorded;
a first storing step which stores identification information for the transfer-booked content;
a comparison step which, when recording of the content has finished, compares the identification information of the content and the identification information stored by said storing step for a match;
a second storing step which, if the match of the identification information is judged by said comparison means, stores the identification information of the match; and
a transfer step which retrieves the content with the identification information stored by said second storing step from the given storage area, based on the identification information, and transfers the content to the terminal.

11. The information transfer method according to claim 10, further comprising:
a step of setting the content to be transferred at a second time,

12. The information transfer method according to claim 10, further comprising:
a step of confirming connection to the terminal,
wherein said transfer means transfers the content to the terminal after the connection to the terminal is confirmed.

13. The information transfer method according to claim 10, wherein said transfer step converts the content into a predetermined format if the content is not the predetermined format.

14. A program to transfer content that was set to be recorded in a given storage area at a first time to a terminal, using identification information to identify the content, causing a computer to function as:
a first storage means for storing identification information of the content set to be recorded;
a receiving means which, when recording of the content has finished, receives the content identification information;
a comparison means that compares the identification information stored by said storage means and the identification information received by said receiving means for a match;
a second storage means which, if the match of the identification information is judged by said comparison means, stores the identification information of the match; and
a transfer means which retrieves the content with the identification information stored by said second storage means from the given storage area, based on the identification information, and transfers the content to the terminal.

15. An electronic device which enables booking of picture recording of desired content, comprising:
means for booking the transfer of content booked to be recorded to an external terminal;
a tuner for receiving the content;
means for compressing the content received according to a predetermined compression format;
means for storing the content that was compressed; and
a transfer means for transferring the content that was compressed to the external terminal according to the transfer booking.

16. The electronic device according to claim 15,
wherein said booking means can set any of a plurality of external terminals for the external terminal to which the content is to be transferred on a per-content basis; and
wherein said transfer means transfers the content to be transferred to the external terminal connected to the electronic device according to the transfer booking.

17. The electronic device according to claim 15, wherein said transfer means periodically seeks for the external terminal that can be connected wirelessly to the electronic device and transfers the content to the external terminal.

18. The electronic device according to claim 15, further comprising:
means for detecting connection to the external terminal, wherein, when connection to the external terminal is detected, said transfer means transfers the content that has been recorded, according to the transfer booking.

19. The electronic device according to claim 15, further comprising
means for setting time to transfer the content that was stored to the external terminal,
wherein said transfer means transfers the content that has been recorded, according to the transfer booking, at the time to transfer that was set.

20. An information transfer method for transferring content that was booked and recorded to an external terminal, comprising the steps of:
booking the transfer of content that was booked to be recorded to the external terminal;
compressing the content according to a predetermined compression format;
storing the content that was compressed to a storage device; and
reading the content that was compressed from the storage device and transferring the content to the external terminal, according to the transfer booking.

21. The information transfer method according to claim 20, further comprising:
a step of setting time to transfer the content to the external terminal,
wherein said transfer means transfers the content that has been recorded, according to the transfer booking, at the time to transfer that was set.

22. An electronic device which enables booking of picture recording of desired content, comprising:
means for booking the transfer of content booked to be recorded to a removable storage medium;
a tuner for receiving the content;
means for compressing the content received according to a predetermined compression format;
means for storing the content that was compressed; and
a transfer means for transferring the content that was compressed to the storage medium according to the transfer booking.

23. An information transfer method for transferring content that was booked and set to be recorded in a given storage area at a first time to a removable storage medium, comprising the steps of:
storing identification information for the content that was booked and set to be recorded;
receiving identification information for content whose recording has finished;
comparing the identification information for the content that was booked and set to be recorded and the identification information for content whose recording has finished for a match;
if the match of the identification information is judged, storing the identification information of the match; and
retrieving the content with the identification information of the match from the given storage area and transferring the content to the storage medium.
